(19) United States
(12) Patent Application Publication
(10) Pub. No.: US 2025/0256176 A1
(43) Pub. Date: Aug. 14, 2025

(54) GOLFING SYSTEM AND METHOD OF USE

(71) Applicant: Mark Eugene Ferguson, Ashburn, VA (US)

(72) Inventor: Mark Eugene Ferguson, Ashburn, VA (US)

(21) Appl. No.: 18/440,843

(22) Filed: Feb. 13, 2024

(51) Int. Cl. A63B 57/00; A63B 71/06; G01S 17/08

(52) U.S. Cl. CPC A63B 57/00; A63B 71/0622; G01S 17/08; A63B 2071/0625; A63B 2071/0658; A63B 2220/12

(57) ABSTRACT

An integrated golf enhancement system, with a focus on both portability and meeting the complete needs of the golfer on the course. The system herein provides a way to accomplish both goals with a portable system device featuring a detachable rangefinder, magnetic divot tool and ball marker storage compartments, a GPS device, combination wireless Wi-Fi modem-router system for creating an internet access area such as a hotspot, a digital display, a set of control apparatus, an internal charging port that enables a battery to be charged, a charging system for accessories, a speaker, and a magnetic apparatus for attaching the system device to a larger object such as a golf cart.

### TECHNICAL FIELD OF THE INVENTION

The present invention relates to the general field of electronically-based sporting equipment, and specifically, to an improved golfing system.

### BACKGROUND

While some may consider golf to be “a good walk spoiled,” many consumers in the US beg to differ. In the US, around 40 million people played golf last year, and golf is now the fastest growing sport.

According to one article, the golf industry now has a market size of over $84 billion. Another survey showed that baby boomers spend an average of just over $1,900 on golf equipment, while members of Generations X and Y spend an average of over $1,200 (https://smartasset.com/retirement/the-economics-of-golf). Clearly, many play golf, more are starting to play, and a good amount is being spent on golf equipment.

This equipment, besides clubs and carts, includes a number of other items. Many people obtain and commonly use rangefinders, speakers, divot tools, and ball markers. Independent of one another, golfers have to keep track and store these items separately. Some speakers today do have GPS technology to measure distances to the green/flag; however, only a rangefinder will give distances to anything the golfer needs to measure.

For instance, rangefinders can do things such as, provide a golfer their specific position within the course, or provide and track the direction and distance between the golfer and the next hole. Some golf speakers with GPS can call out the golfer's distance to the green or pin. They can also provide information that can be helpful such as weather conditions or club offers or changes. They can further provide entertainment during downtime, such as between holes and when it is another's turn. Divot tools are one- or two-pronged tools that can repair divots (i.e., impact marks that are usually chunks of grass or turf that can become dug out of the ground from golfers and their clubs during play, leaving a marked and uneven ground in that area). Ball markers are artificial objects used to mark the spot of a ball to be lifted, such as a tee, a coin, an object made to be a ball marker or other small piece of equipment.

Further, while some speakers today do have GPS technology to measure a golfer's position within the course, this is of limited use, as currently this only provides the golfer a distance from their current position to the green or pin. Only a rangefinder will provide a golfer with the ability to measure distances in a variety of situations; for example, if the golfer wants to measure the distance to a dogleg on the fairway, measure the distance to lay up short of, or clear a sand trap or hazard, or the hole is measured from the cart path, and the golfer needs a measurement from their ball position, a distance away from the cart.

However, carrying and using all these and other golfing tools presents a number of unaddressed challenges. Golfers have to remember to bring them, keep track of, and store these various items separately, to include speakers, rangefinders, divot tools, and ball markers. They may well have to bring everything separately, find a place for each item within the golf cart or carry them around. Further, there may be no convenient place within the golf cart to store all these items.

If the cart is not owned by the golfer (which is the usual situation), the golfer has to find places for each item within the golf cart each time. As golf carts have different layouts and designs, the golfer may have to place the items in different places each time. This makes the items more difficult to place and keep track of during play, and easier to forget when leaving. In addition, this might also require a separate bag/pouch to keep divot tools and ball markers.

Another issue is that the rangefinders and speakers independently require power. Most golf speakers today have batteries capable of recharging while rangefinders are typically powered by replaceable batteries. If the power to one or both of these goes out, either or both would become useless, which can negatively impact the golf experience. It can be easy to forget to charge such devices, or if battery powered, continually replace the batteries enough.

In the way of equipment, there are currently a number of equipment options, but each has unaddressed limitations. For example, there are several speakers in the market, such as Bushnell Wingman™ and BlueTee™. These are popular and have GPS options, but neither has a rangefinder.

Another issue of keeping up with disparate pieces of equipment is that the golfer has to remember to remove and take everything with them when their time at the course is over. They have to remember, for example, their clubs, rangefinder, speakers, divot tools, ball markers, often their smartphones, and any other items the golfer brought. It is common for golfers to leave their speakers or rangefinders in the cart, and in many cases, they are lost forever. These independent devices are expensive to replace.

There are, generally, electronic devices relating to GPS, rangefinders, video systems, or combinations thereof that can be magnetically attached to a golf cart. Also, storage boxes for storing golf accessories within a golf cart are known within the art. However, none of these addresses the issues noted herein, let alone provides a single system that does so.

Accordingly, there is a thus-far unmet need for a single system that keeps golfing components and tools in proximity to each other, fully usable and easy to pull together, take and use on the golf course, and remember to take when leaving. There is also a need for such a system that will stay charged and provides Bluetooth, GPS or other signals that will help or improve the experience of a game of golf.

### SUMMARY

Shown and described herein is an integrated golf enhancement system, with a focus on both portability and meeting the complete needs of the golfer on the course.

In an embodiment of the system, the system is generally comprised of a golfing system device, rangefinder and related devices, speaker and related devices and controls, GPS system and tracker, and other related devices.

A portable golfing system device holds most of the system components. This makes these components easy to find, keep track of, and move without forgetting or losing individual components. A power button can be depressed to turn the system on.

Another important component is a rangefinder. The rangefinder is seated within an individual rangefinder container. The golfer can remove the rangefinder from the rangefinder container and use it to find a distance between the golfer and the green.

When the golfer is finished with the rangefinder, they can place it back into the rangefinder container, and depress it into a locked position. The rangefinder is locked into place within the rangefinder container by locking apparatus as known and understood within the art. This secures the rangefinder within the system when not in use. When it is to be used, the golfer can use a release button or other release apparatus as known in the art to release the rangefinder from the rangefinder container. The rangefinder can be released and removed for use.

Also present is at least one speaker which can supply various audio outputs, including audio information from a signal from the rangefinder. The speaker can also be connected with a GPS tracker and read audio information from the tracker. Further, the speakers can read input from a smartphone or other device, related to the golf game, entertainment, or other input. Speaker controls can be used to control at least one aspect of the at least one speaker. The speaker can also be controlled by other apparatus known in the art, such as by a remote control, or a software application (app) on a smartphone.

The device can also be charged and charge other components and devices. Present is at least a charger port to charge the device. Also present is at least one charging port, which enables the device to charge any system components, such as the rangefinder, or other more loosely related components, such as, e.g., a smartphone or tablet. This ensures that each of these related devices is also charged during golf. This prevents, among other things, having to call the game early because of dead devices.

In an embodiment, the GPS tracker can be secured onto the golfing system device, then be removed for use. It can be placed anywhere a golfer chooses, such as at the next hole, to provide information about its location, providing an alternative method of locating the hole relative to the golfer. In addition, the GPS tracker can be used to locate the golfing system device, if missing, from another connected device, such as a smartphone or computer. Further, GPS equipment can be provided within the golfing system device and used to show the position of the golfer, such as, e.g., within the golf course, or in relation to other holes of the course.

A display can show much helpful information to the golfer, including range from the rangefinder or GPS tracker, relative GPS position, and percent charge of the golfing system device. It can also show other information, such as what entertainment or radio channel the golfing system device has been placed on, volume, or other desired system information.

In other embodiments, at least one divot tool compartment and ball marker compartment can be included with the device. In an embodiment, these are located at the top of the device. The divot tool compartment and ball marker compartment can be shaped so as to remove-ably accommodate at least one divot tool and at least one ball marker. The divot tool and ball marker can both be easily removed from the respective divot tool compartment and ball marker when these respective devices are to be used, then returned securely to their respective compartments when not in use. Thereby, a golfer can know where these tools are, have access to them, and know where they are at all times.

In some embodiments, the golfing system device is attached to a golf cart. A securing apparatus is provided and added to the golfing system device. In an embodiment, the securing apparatus is comprised of a magnetic strip provided on the back of the device, or a set of magnets or the like. The magnetic strip or magnets help secure the golfing system device to the golf cart. As the golf cart is moved around, the secured golfing system device moves with it. The golfer does not have to be concerned with where the device is. When the golfer is done with the game, the golfer can simply detach the device and take it away.

In another embodiment, a mount in the shape of a half circle is attached to the system device. In turn, this securing apparatus can be attached to the golf cart.

Also shown is that a wireless source device, such as a smartphone or other computerized device, can also be added to the system. The wireless source device can be tethered or otherwise connected to the system device via Bluetooth, hotspot, or other technology in the art. With this integration, data can be sent from the system device to the wireless source, particularly if it is a smartphone or tablet, or from the wireless source device to the source device. For a few examples, music, news, club information, or other media can be sent from the smartphone to the system device and/or at least one speaker.

A rangefinder tracker app can be downloaded onto the smartphone and used to display information on the phone obtained from the rangefinder. Alternatively, data from the rangefinder or GPS can be sent to the smartphone. Further, a tracker or tracking app can be added to the smartphone, so that if either the smartphone or device get too far from each other, an alert will sound, preventing the loss of either.

In another embodiment, a battery that is connected to the charger port and A charging port is connected to other powered components throughout the device by a set of connecting wires. There can also be, as shown herein, signal connections between components of the device, such as between the rangefinder and display and/or speaker, the Wi-Fi modem-router and display and/or speaker, and between the device and other devices, such as smartphone or satellite.

It is to be understood that, while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

### BRIEF DESCRIPTION OF THE DRAWINGS

FIG. 1 is a perspective view of an embodiment of the invention.

FIG. 2 is another perspective view of the embodiment of FIG. 1 in a slightly altered configuration.

FIG. 3 is another perspective view of the embodiment of FIG. 1, showing a component of the invention in greater detail.

FIG. 4 is a top perspective view of the embodiment of FIG. 1, with portions removed.

FIG. 5 is the top plan view of FIG. 4, with the portions added.

FIG. 6 shows the embodiment of FIG. 1, displaying a securing feature of the invention.

FIG. 7 shows the embodiment of FIG. 6, featuring the invention secured to a golf cart.

FIG. 8 shows the embodiment of FIG. 1, displaying another possible securing feature of the invention.

FIG. 9 shows the embodiment of FIG. 8, featuring the invention secured to a golf cart.

FIG. 10 shows another possible configuration of the invention.

FIG. 11 shows the embodiment of FIG. 1, displaying further possible features of the invention.

FIG. 11A features the embodiment of FIG. 11 in use.

FIG. 12 shows the embodiment of the invention, featuring the integrated nature of the invention.

### DETAILED DESCRIPTION OF PREFERRED EMBODIMENTS

Shown and described herein is an integrated golf enhancement system, with a focus on both portability and meeting the complete needs of the golfer on the course. The system herein provides a way to accomplish both goals with a combination Wi-Fi system (e.g., Bluetooth) and magnetic speaker (to attach to a golf cart) with digital display, charging system for accessories, detachable rangefinder, and magnetic divot tool and ball marker.

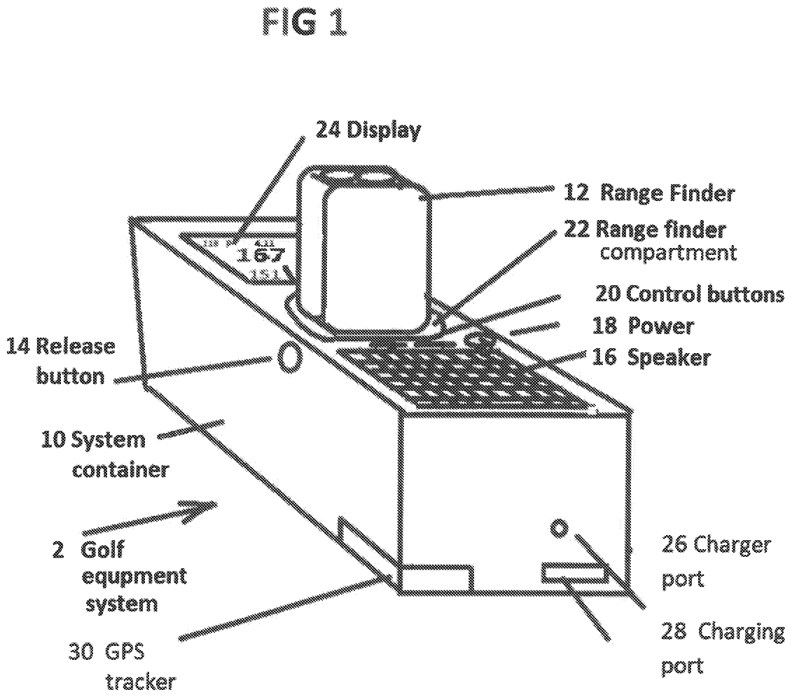

Turning to FIG. 1, an embodiment of the system 2 is disclosed. The system 2 is generally comprised of a golfing system device 10, rangefinder 12 and related devices, speaker 16 and related devices and controls, GPS system and tracker 30, and other related devices.

An important component of the overall system 2 is a golfing system device 10. The portable golfing system device 10 holds most of the system components. This makes these components easy to keep find, keep track of, and move without forgetting or losing individual components. A power button 18 can be depressed to turn the system 2 on.

Another important component is a rangefinder 12. The rangefinder 12 is seated within an individual rangefinder container 22. The rangefinder 12 is shown in an extended position, ready for use. The rangefinder 12 can be removed by a user and used. The rangefinder 12 is a device that can measure distance between it and another point, such as from the golfer or ball to the next green. The rangefinder 12 can emit a radio wave, laser, radar, infrared, or other form of electro-magnetic (EM) energy, receive the energy back from a target, then measure the distance by timing the interval between the transmission and reception of the electromagnetic waves. Current rangefinders typically employ visible or infrared light rather than invisible EM waves. The golfer can remove the rangefinder 12 from the rangefinder container 22 and use it to find a distance between the golfer and the green.

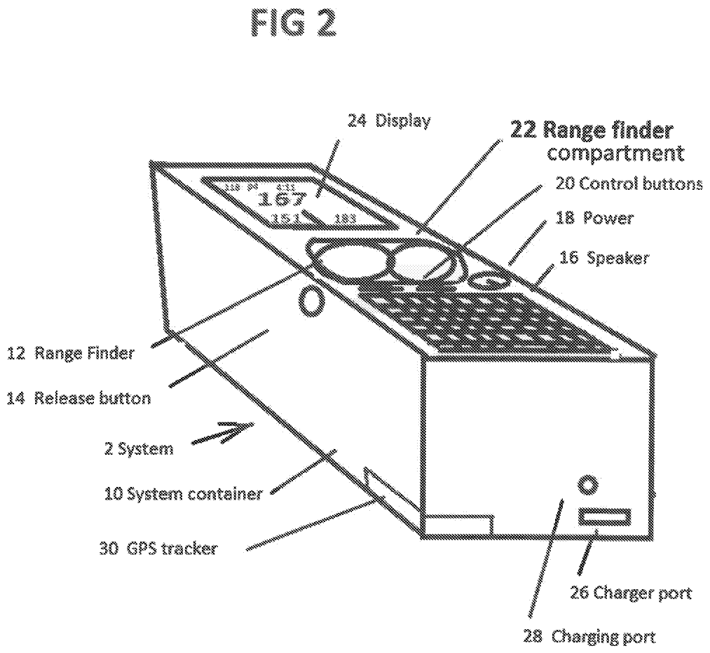

Turning briefly to FIG. 2, when the golfer is finished with the rangefinder 12, they can place it back into the rangefinder container 22 and depress it into a locked position. The rangefinder 12 is locked into place within the rangefinder container 22 by locking apparatus as known and understood within the art. This secures the rangefinder 12 within the system 2 when not in use. When it is to be used, the golfer can use a release button 14 or other release apparatus as known in the art to release the rangefinder 12 from the rangefinder container 22.

Returning to FIG. 1, the rangefinder 12 is released and can be removed for use. Also present is at least one speaker 16 which can supply various audio outputs, including audio information from a signal from the rangefinder 12. The speaker 16 can also be connected with a GPS tracker 30 and read audio information from the tracker 30. Further, the speakers can read input from a smartphone or other device, related to the golf game, entertainment, or other input. Speaker controls 20, in this embodiment a pair of volume buttons, can be used to control at least one aspect of the at least one speaker 16. The speaker 16 can also be controlled by other apparatus known in the art, such as by a remote control, or a software application (app) on a smartphone.

The device 10 can also be charged and charge other components and devices. Present is at least an internal charger port 26 to charge the device 10. Also present is at least one external charging port 28, which enables the device 10 to charge any system components, such as the rangefinder 12, or other more loosely related components, such as, e.g., a smartphone or tablet. This ensures that each of these related devices is also charged during golf. This prevents, among other things, having to call the game early because of dead devices.

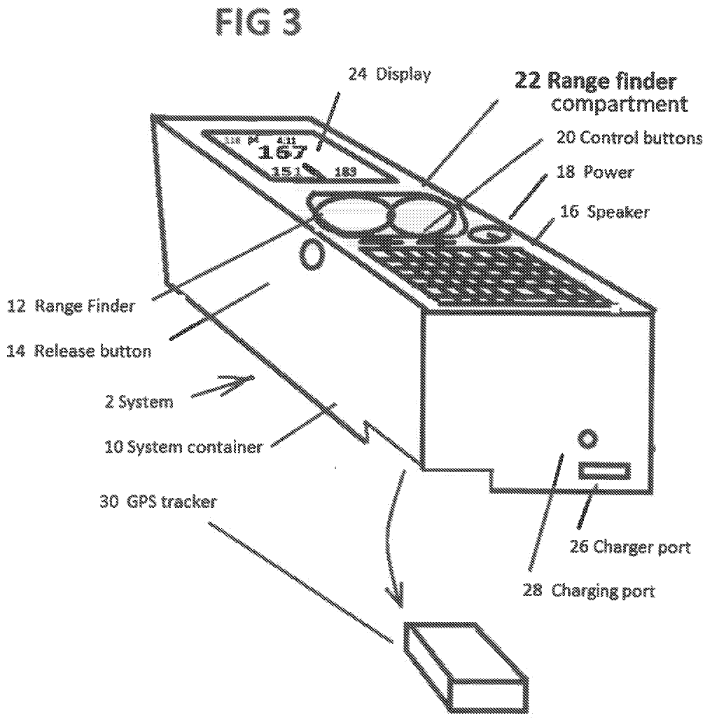

Turning to FIG. 3, the GPS tracker 30 can be secured onto the golfing system device 10, then removed for use. It can be placed anywhere a golfer chooses, such as at the next hole, to provide information about its location, providing an alternative method of locating the hole relative to the golfer. In addition, the GPS tracker 30 can be used to locate the golfing system device 10, if missing, from another connected device, such as a smartphone or computer. Further, GPS equipment can be provided within the golfing system device 10 and used to show the position of the golfer such as, e.g., within the golf course, or in relation to other holes of the course.

A display 24 can show much helpful information to the golfer, including range from the rangefinder 12 or GPS tracker, relative GPS position, and percent charge of the golfing system device 10. It can also show other information, such as what entertainment or radio channel the golfing system device 10 has been placed on, volume, or other desired system information.

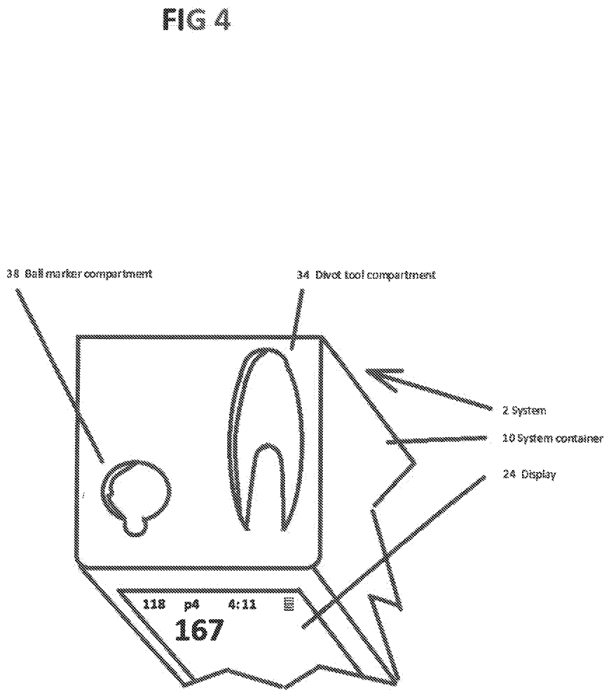

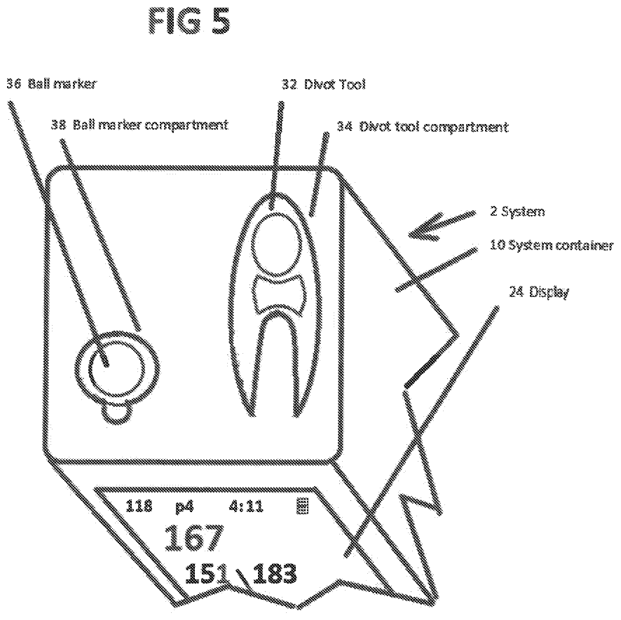

Turning to FIG. 4, at least one divot tool compartment 34 and ball marker compartment 38 can be included with the device 10. In this embodiment, these are located at the top of the device 10. Turning to FIG. 5, the divot tool compartment 34 and ball marker compartment 38 are shaped so as to remove-ably accommodate at least one divot tool 32 and at least one ball marker 36. For purposes of this invention, the term remove-ably means the respective compartments 34, 38 are configured so that the at least one divot tool 32 and at least one ball marker 36 are securely held in the compartments 34, 37, yet can be easily removed when in use. Turning to both FIGS. 4-5, the divot tool 32 and ball marker 36 can both be easily removed from the respective divot tool compartment 34 and ball marker 36 when these respective devices are to be used, then returned securely to their respective compartments 34, 38 when not in use. Thereby, a golfer can know where these tools 32, 36 are, have access to them, and know where they are at all times.

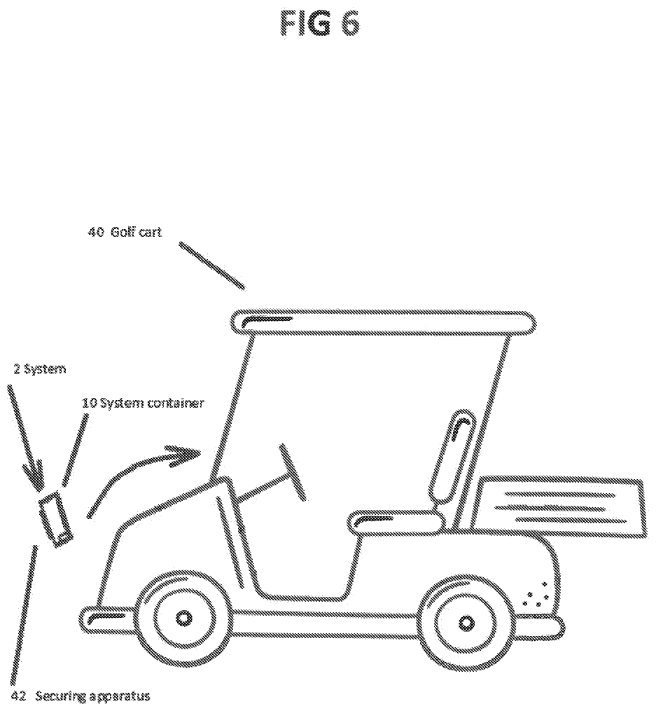

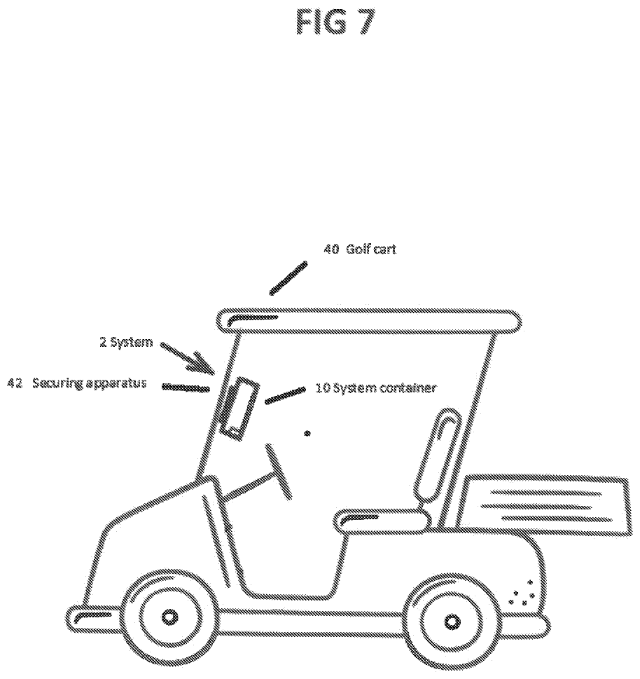

Turning to FIGS. 6-7, it is shown how the golfing system device 10 can be attached to keep it secured to a larger object to keep it secure and functioning. In these embodiments, the golfing system device 10 is attached to a golf cart 40. Securing apparatus 42 are provided and added to the golfing system device 10. In this embodiment, the securing apparatus 42 is comprised of a magnetic strip provided on the back of the device 10, or a set of magnets or the like. The magnetic strip or magnets help secure the golfing system device 10 to the golf cart 40. As the golf cart 40 is moved around, the secured golfing system device 10 moves with it. The golfer does not have to be concerned with where the device 10 is. When the golfer is done with the game, the golfer can simply detach the device 10 and take it away.

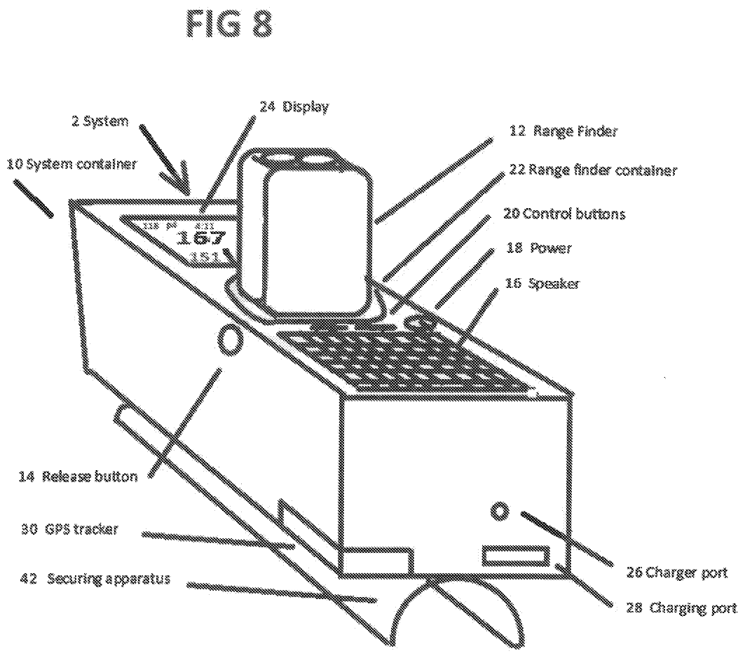

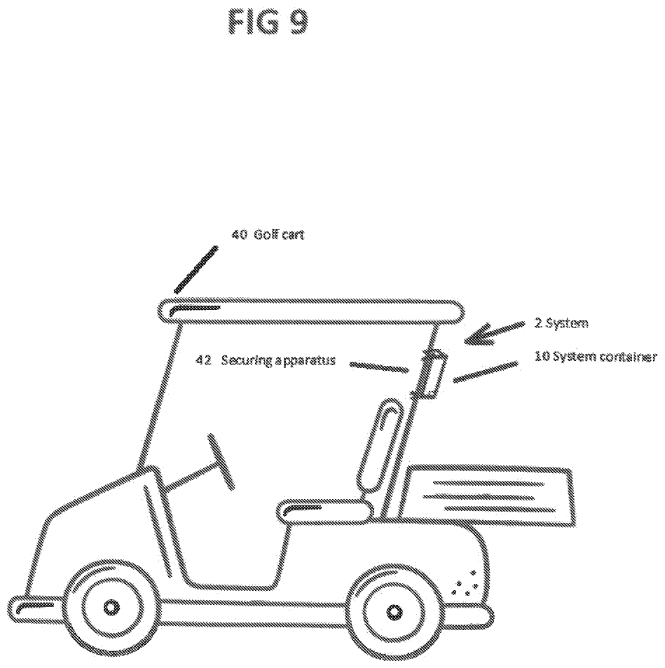

Any securing apparatus known in the art can be used. Turning to FIGS. 8-9, another securing apparatus 42 is shown in use. A mount in the shape of a half circle is attached to the system device 10. In turn, this securing apparatus 42 can be attached to the golf cart 40. This is particularly shown in FIG. 9.

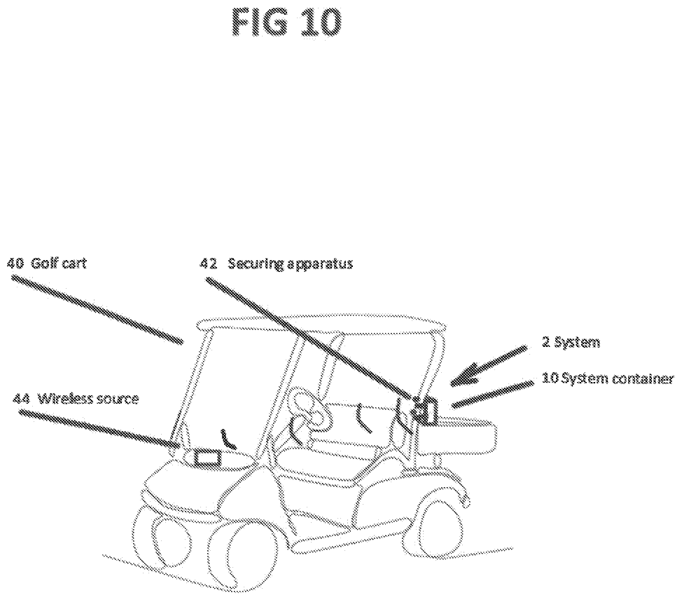

Turning to FIG. 10, the system device 10 can be attached to the golf cart 40 in any suitable position.

Also shown is that a wireless source device 44, such as a smartphone or other computerized device, can also be added to the system 10. The wireless source device 44 can be tethered or otherwise connected to the system device 10 via Bluetooth, hotspot, or other technology in the art. With this integration, data can be sent from the system device 10 to the wireless source 44, particularly if it is a smartphone or tablet, or from the wireless source device 44 to the source device 10. For a few examples, music, news, club information, or other media can be sent from the smartphone 44 to the system device 10 and/or at least one speaker 16. A rangefinder tracker app can be downloaded onto the smartphone 44 and used to display information on the phone obtained from the rangefinder 12. Alternatively, data from the rangefinder 12 or GPS 30 can be sent to the phone. Further, a tracker or tracking app can be added to the smartphone 44, so that if either the smartphone 44 or device 10 get too far from each other, an alert will sound, preventing the loss of either.

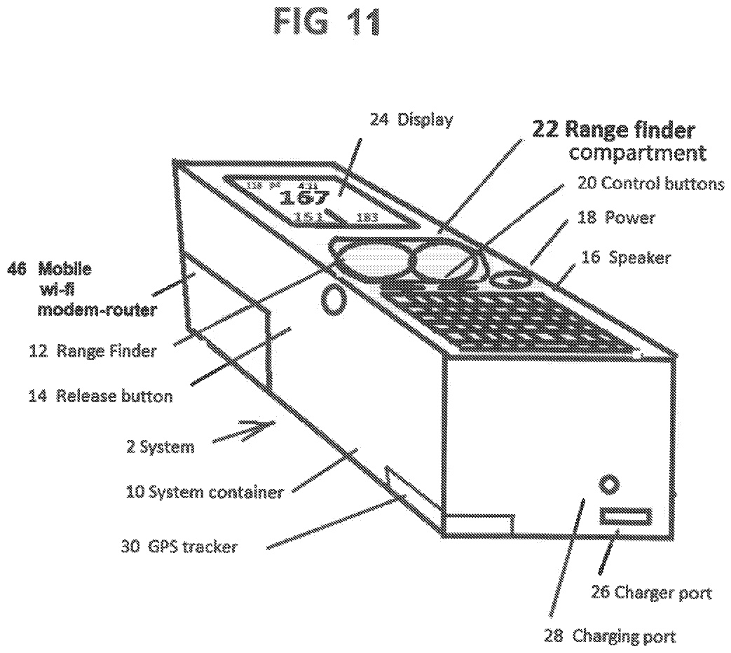

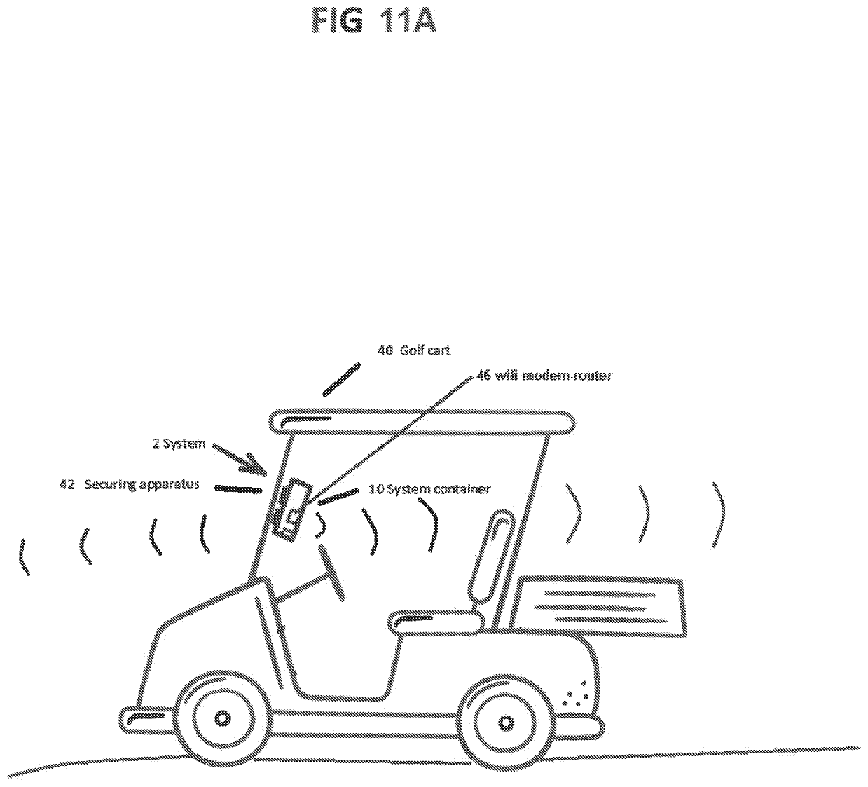

Turning to FIG. 11, the system 2 can have further integrated features. In this embodiment, the golfing device further includes a Wi-Fi generating modem-router device 46. The Wi-Fi modem-router device 46 can interact with an internet service provider, or similar service, to obtain and provide an internet signal. As an example, the Wi-Fi modem-router device 46 can electronically link up with a satellite or similar service to obtain a signal.

Turning to FIG. 11a, when the Wi-Fi modem-router is activated, it can create a local network around the device 10. This can be used to provide a signal to the GPS tracker 30 or other similar location device. It can also provide a local internet network instead of having to connect the device 10 to a smartphone or other device. This can be used for similar purposes to a smartphone hotspot, such as providing music, entertainment, or club news. Further, it can also provide a powerful internet network that other nearby golfers can use. This can be, among other things, an aid to popularity. If any of the golfers has important news to keep up with, such as work email, this can ensure that the golfers are kept up to date, allowing each to enjoy their game without concern for what they are missing.

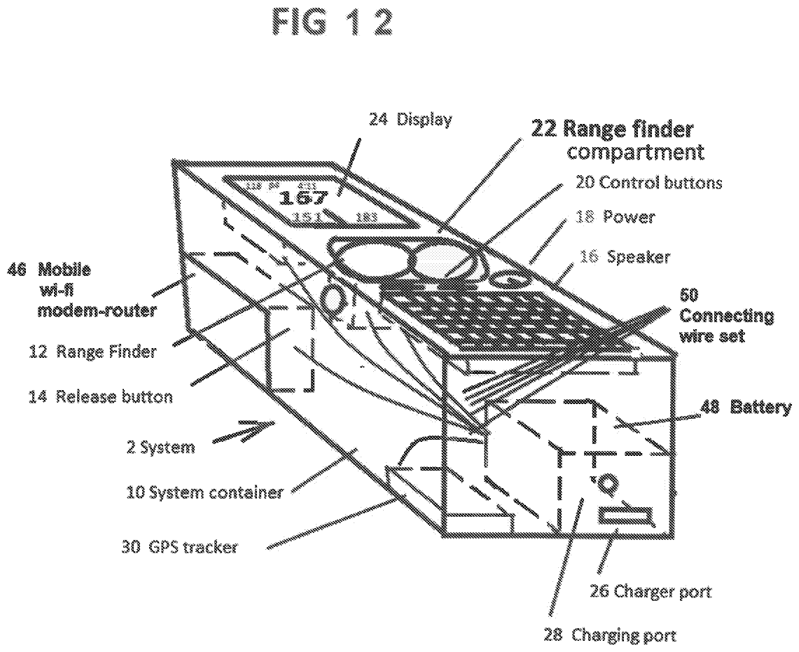

Turning to FIG. 12, the integrated nature of the system 2 is shown. A battery 48 that is connected to the internal charging port 26 and external charging port 28 is connected to other powered components throughout the device 10 by a set of connecting wires 50. There can also be, as shown herein, signal connections between components of the device 10, such as between the rangefinder 12 and display 24 and/or speaker 16, the Wi-Fi modem-router 46 and display 24 and/or speaker 16, and between the device 10 and other devices, such as smartphone or satellite.

### EXAMPLE 1

Dave is an avid golfer who really enjoys the sport. Dave has a number of golfing devices and equipment, including clubs, smartphone, GPS, rangefinder, divot tools and ball marker. Dave practically needs a checklist to make sure he does not miss anything when he leaves the house. If he misses an item, then he does not have it with him when starting his game. Dave also has to remember to charge everything the night before, or he could end up with a dead device, such as smartphone or rangefinder, on the course.

Once out to golf, a number of these accessories can become detached, lost, or run out of power. Dave has to keep track of everything, while carrying his clubs around and concentrating on the game itself. Keeping track of these items can be cumbersome and annoying, and certainly can detract from the fun of the game. Once the game is over, Dave has to remember to pack up every item and take it with him. Dave, as many have, has left a couple of items behind in a golf cart. He then had to check the lost-and-found and hope for the best. He got a divot tool back one time, but another time, he never saw a rangefinder again.

Dave obtains this system 2. Now he has a turnkey all-in-one solution that can keep everything together, charged, and on a Bluetooth or Wi-Fi network. He has a golf game the next day. He plugs in the internal charger port 26 of the system device 10, and everything within the device 10 will be charged. This can include a direct charge to devices like the rangefinder 12, or if it operates with batteries, charging of these batteries. If he needs any external devices charged, he can plug them into the external charging port 28.

He takes the device 10 to the golf course the next day and turns on the power with the power button 18. He has not forgotten anything because it is all within or attached to the device 10. He can take the device 10, and with securing apparatus 42, secure it to a golf cart. Now he will be able to easily locate the device 10 and anything within or attached to the device all day. Dave is able to pull out the divot marker and ball marker tools 32, 36 from their respective compartments 34, 38 to use, then return. He is able to keep track of these small devices.

Dave can pull the rangefinder 12 from the rangefinder container 22 with the release button 14, use whenever needed, and return it when done. He can connect a wireless source device 42, such as a smartphone, into the system device 10. He can read GPS or rangefinder data from the system on his smartphone, through an app, or play music, news or other input from the smartphone 42, out the speaker(s) 16, controlling the speaker(s) 16 with control buttons, such as volume buttons 20. He uses the rangefinder 12 to find the range between him and the next hole. The range shows on the readable display 24 and is transmitted in audio from the speaker(s) 16.

When Dave is finished at the course, he can simply pick up his bag, the device 10, and wireless source (i.e., smartphone) 44 and leave. With most devices secured to the system device 10, everything should be present. And if the smartphone and device 10 are, wired or wirelessly, connected to each other, if one is removed, a signal will alert if the other is left behind, so they will both be remembered.

When Dave gets home, he puts the system device 10 on the internal charging port 26, and everything will be charged up again for next time.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. An integrated golfing enhancement system, comprising:
a golfing system device,
at least one rangefinder,
at least one speaker connected to the system device, and
a location tracking apparatus connected to the system device,
at least one system control apparatus connected to at least one component of the system device,
at least one internal charging port connected to at least one battery within the system device, wherein the internal charging port is configured to enable the battery to be charged,
and a display on the device configured to show at least one type of information from at least one system component, at least one external type of information, or both.

2. An integrated golfing enhancement system according to claim 1, wherein the location tracking apparatus is a GPS system.

3. An integrated golfing enhancement system according to claim 1, wherein the at least one system control apparatus is at least one power button.

4. An integrated golfing enhancement system according to claim 1, wherein the golfing system device is further comprised of a rangefinder container,
and wherein the rangefinder container is configured such that the rangefinder can be seated within it,
and wherein the rangefinder container is further comprised of apparatus for securing the rangefinder within the rangefinder container, and a release mechanism configured to release the rangefinder from the rangefinder container.

5. An integrated golfing enhancement system according to claim 1, wherein the rangefinder can measure distance by radio wave, laser, radar, or infrared waves. The rangefinder 12 is locked into place within the rangefinder.

6. An integrated golfing enhancement system according to claim 1, wherein the at least one speaker is configured to receive and transmit audio information from at least the rangefinder, the location tracking apparatus, and at least one computerized device.

7. An integrated golfing enhancement system according to claim 1, wherein the at least one speaker is further comprised of at least one volume control button, at least one speaker control apparatus, or both.

8. An integrated golfing enhancement system according to claim 1, wherein the the device is further comprised of at least one external charging port configured to charge at least one system component, at least one external component, or both.

9. An integrated golfing enhancement system according to claim 1, and wherein the device is configured to be capable of securing or releasing the location tracking apparatus.

10. An integrated golfing enhancement system according to claim 1, wherein the display is a digital display,
and is configured to show range information from the rangefinder, information from the location tracking apparatus, speaker volume, charge level of the golfing system device entertainment or radio channel information, or any combination of the above.

11. An integrated golfing enhancement system according to claim 1, wherein the golfing system device is further comprised of at least one divot tool compartment configured to remove-ably accommodate at least one divot tool, and at least one ball marker compartment configured to remove-ably accommodate at least one ball marker.

12. An integrated golfing enhancement system according to claim 1, wherein the system is further comprised of a securing apparatus configured to secure the system device to another object.

13. An integrated golfing enhancement system according to claim 1, wherein the system is further comprised of securing apparatus configured to remove-ably secure the system device to another object.

14. An integrated golfing enhancement system according to claim 13, wherein the securing apparatus is comprised of at least one magnetic strip attached to one side of the system device, a set of magnets attached to one side of the system device, a mount in the general shape of a half circle configured to be attached to a golf cart, or a combination thereof.

15. An integrated golfing enhancement system according to claim 1, wherein the system is further comprised of at least one wireless source device configured to be wirelessly connected to the system device.

16. An integrated golfing enhancement system according to claim 15, wherein the wireless source device is configured to transmit information from a rangefinder tracking app, information from a smartphone tracking app, other audio transmission, or a combination thereof.

17. An integrated golfing enhancement system according to claim 1, wherein the battery is connected to at least one other component within or secured to the system device by at least one connecting wire, connected to at least one external charging port by at least one connecting wire, or both.

18. An integrated golfing enhancement system according to claim 1, wherein the at least one other component is the rangefinder, display, and speaker.

19. An integrated golfing enhancement system according to claim 1, further comprising a Wi-Fi generating modem-router device configured to provide a wireless internet signal capable of creating a local network around the system device.

20. An integrated golfing enhancement system according to claim 19, wherein the battery is connected to the Wi-Fi generating modem-router device by at least one connecting wire and the system is configured so that the battery provides power to the Wi-Fi generating modem-router device.
